(19) United States
(12) Patent Application Publication
(10) Pub. No.: US 2026/0111245 A1
(43) Pub. Date: Apr. 23, 2026

(54) SYSTEMS AND METHODS FOR AN ARTIFICIAL INTELLIGENCE AGENT FOR GRAPHICAL USER INTERFACE AUTOMATION

(71) Applicant: Salesforce, Inc., San Francisco, CA (US)

(72) Inventors: Yiheng Xu, Hong Kong (HK); Tianbao Xie, Palo Alto, CA (US); Amrita Saha, Singapore (SG); Caiming Xiong, Menlo Park, CA (US)

(21) Appl. No.: 19/205,654

(22) Filed: May 12, 2025

Related U.S. Application Data
(60) Provisional application No. 63/708,565, filed on Oct. 17, 2024.

(51) Int. Cl. G06F 9/451; G06F 40/284; G06F 40/40

(52) U.S. Cl. CPC G06F 9/451; G06F 40/284; G06F 40/40

(57) ABSTRACT

Embodiments described herein provide a unified framework for GUI agents to generate automatic task executions on GUIs based on vision observation and action spaces across diverse environments of GUIs. Specifically, vision-based grounding may be generated to improve generalization and reduce inference costs while employing a standardized action space with a plugin system to facilitate consistent learning and interaction across various platforms. In one embodiment, explicit visual planning and reasoning may be integrated into GUI agent, enabling autonomous navigation and interaction within complex digital environments.

### CROSS REFERENCE(S)

The instant application is a nonprovisional of and claim priority under 35 U.S.C. 119 to co-pending and commonly-owned U.S. nonprovisional application No. 63/708,565, filed Nov. 27, 2024, which is hereby expressly incorporated herein by reference in its entirety.

### TECHNICAL FIELD

The embodiments relate generally to machine learning systems for artificial intelligence (AI) agents, and more specifically to AI agents for performing graphical user interface (GUI) tasks.

### BACKGROUND

AI conversation agents, commonly known as chatbots or virtual assistants, can be applied to a wide range of practical applications across various industries. In customer service, AI agents can handle user inquiries, provide support, and resolve issues 24/7, improving customer satisfaction and reducing operational costs. In healthcare, AI agents can offer initial consultations, answer health-related questions, and remind patients to take their medications. In the e-commerce sector, AI conversation agents can assist with product recommendations, order tracking, and personalized shopping experiences. In information technology (IT) support, these agents can guide users through troubleshooting steps, helping them resolve software and hardware issues. Specifically, for network hazards, AI conversation agents can diagnose connectivity problems, suggest corrective actions, and provide step-by-step guidance to ensure network security and stability. Their versatility and ability to handle diverse tasks make them valuable tools in enhancing efficiency and user experience in various fields.

AI agents often employ a neural network based generative language model to generate an output such as in the form of a text response, or a series actions to complete a complex task, such as to network issue troubleshooting, etc. Such generative language model receives a natural language input in the form of a sequence of tokens, and in turn generates a predicted distribution over a token space conditioned on the input sequence. Generated output tokens over time may in turn form the text response, or actions for completing the task.

A class of AI agents is designed to execute graphical user interface (GUI) tasks such as completing form entries across heterogeneous digital platforms including web browsers, desktop applications, and mobile interfaces. However, automating such tasks presents significant technical challenges due to the high variability in GUI layouts, element hierarchies, visual appearances, and interaction modalities across environments. Existing GUI agents frequently depend on structured or textual representations of interface elements (e.g., DOM trees, accessibility layers, or manually defined schemas), limiting their generalizability and effectiveness in unstructured or visually dynamic settings where such representations are unavailable or inconsistent.

### BRIEF DESCRIPTION OF THE DRAWINGS

FIG. 1A shows an example operation of a language model based AI agent, according to embodiments of the present disclosure.

FIG. 1B is a simplified diagram illustrating an example interaction between the GUI agent and the computing environment, according to embodiments described herein.

FIG. 2 is a simplified diagram illustrating a training framework for the GUI agent, according to some embodiments.

FIG. 3 is a simplified diagram illustrating a data generation pipeline to generating training data for the training framework shown in FIG. 2, according to some embodiments.

FIG. 4 is a simplified diagram illustrating a computing device implementing the GUI agent described in FIG. 1, according to some embodiments.

FIG. 5 is a simplified diagram illustrating a neural network structure, according to some embodiments.

FIG. 6 is a simplified block diagram of a networked system suitable for implementing the GUI agent framework described in FIGS. 1-5 and other embodiments described herein.

FIG. 7 is an example logic flow diagram illustrating a method of building a GUI agent to automate tasks across different computing platforms based on the framework shown in FIGS. 1A-6, according to some embodiments described herein.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

As used herein, the term “network” may comprise any hardware or software-based framework that includes any artificial intelligence network or system, neural network or system and/or any training or learning models implemented thereon or therewith.

As used herein, the term “module” may comprise hardware or software-based framework that performs one or more functions. In some embodiments, the module may be implemented on one or more neural networks.

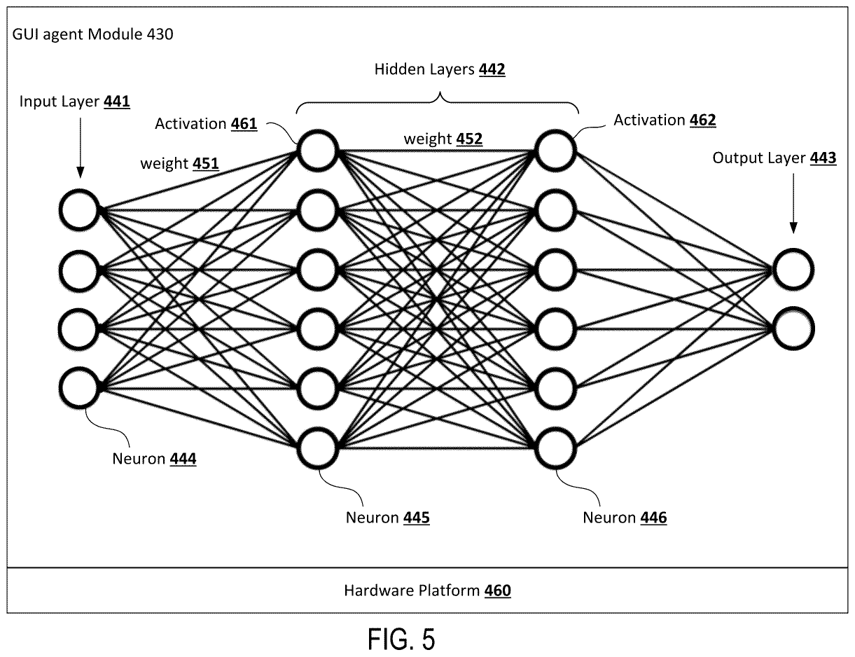

As used herein, the term “Transformer” may refer to an architecture of a deep learning model designed to process sequential data, such as text, using a mechanism called self-attention. The Transformer architecture handles an entire input sequence of tokens (such as words, letters, symbols, etc.) in parallel, and often generate an output sequence of tokens sequentially. The Transformer architecture may comprise a stack of Transformer layers, each of which contains a self-attention module to weigh the importance of each token relative to other tokens in the sequence and a feed-forward module to further transform the data. Additional details of how a Transformer neural network model processes input data to generate an output is provided in relation to FIG. 5.

As used herein, the term “Large Language Model” (LLM) may refer to a neural network based deep learning system designed to understand and generate human languages. An LLM may adopt a Transformer architecture that often entails a significant amount of parameters (neural network weights) and computational complexity. For example, LLM such as Generative Pre-trained Transformer (GPT) 3 has 175 billion parameters, Text-to-Text Transfer Transformers (T5) has around 11 billion parameters. An LLM may comprise an architecture of mixed software and/or hardware, e.g., including an application-specific integrated circuit (ASIC) such as a Tensor Processing Unit (TPU).

As used herein, the term “generative artificial intelligence (AI)” may refer to an AI system that outputs new content that does not pr-exist in the input to such AI system. The new content may include text, images, music, or code. An LLM is an example generative AI model that generate tokens representing new words, sentences, paragraphs, passages, and/or the like that do not pre-exist in an input of tokens to such LLM. For example, when an LLM generate a text answer to an input question, the text answer contains words and/or sentences that are literally different from those in the input question, and/or carry different semantic meaning from the input question.

As used herein, the term “AI agent” may refer to a set of software and/or hardware that processes information from its environment and takes action to achieve specific goals such as executing a task. For example, an AI agent (like a chatbot or virtual assistant) might use an LLM as a component but also integrate tools like web browsing, APIs, databases, and other forms of reasoning to complete tasks.

### Overview

Graphical User Interfaces (GUIs) constitute the primary interaction layer for software applications across various platforms, including web browsers, desktop environments, and mobile operating systems. A GUI agent is a software-based system built upon a multi-modal AI model, or a vision-language model (VLM), designed to automate interactions with these interfaces by simulating user actions such as clicking, typing, scrolling, or selecting items. These agents are typically used to perform structured tasks in applications without requiring modifications to the underlying software, enabling automation in systems or third-party services.

To perform such tasks, a GUI agent may execute three processes: (1) GUI understanding, which involves parsing visual elements in high-resolution and often complex interfaces to identify actionable components such as input fields, buttons, or menus; (2) GUI grounding, which translates natural language or symbolic instructions into references to specific visual elements based on their appearance and context; and (3) GUI planning and reasoning, which uses the current visual state, prior observations, and past actions to determine a sequence of operations that will achieve a specified goal and the reasoning associated with such sequence of operation, e.g., “inner monologue” of the GUI agent.

For example, a GUI agent may perform a flight booking operation in response to a user request to book a flight. The GUI agent may interpret a user request, locate and interact with appropriate interface elements on a travel booking website (e.g., entering the destination “Paris” into a text box, selecting a date using a calendar widget, and confirming a selection via a button click), and continue executing a multi-step interaction based on the evolving GUI state.

Existing GUI agent may focus on mapping natural language instructions to textual representations of GUIs, such as HTML or accessibility trees. This methodology presents several technical limitations. First, GUIs are inherently visual entities, and image-based representations align more closely with human cognitive processes for interface interpretation. Second, textual representations exhibit significant variation across different environments, complicating model generalization and restricting the availability of consistent training data. Third, these textual representations tend to be verbose and structurally complex, resulting in increased computational overhead and extended inference times compared to more compact image encodings. GUI agents may improve their performance across diverse environments by unifying observations as images and grounding instructions to specific image coordinates.

In addition, the action spaces and control APIs for GUI interactions demonstrate substantial variation across different environments (e.g., desktop, web, mobile, etc.), particularly when observations are text-based. This heterogeneity extends to environments within the same platform, where action spaces can differ significantly. Such diversity restricts the quantity of training data available for each specific environment, impeding the development of models capable of effective cross-platform generalization. A unified action space that abstracts these environmental differences represents a critical requirement for developing robust and adaptable GUI agents. While some research has attempted to unify digital agent data across diverse interfaces, these interfaces frequently do not share common interaction logic. In contrast, GUIs across desktop, web, and mobile platforms inherently share similar human-computer interaction patterns, which could potentially facilitate their unification through consistent visual observations and action spaces.

Further, existing GUI agents typically either rely on the reasoning capabilities of LLMs to plan GUI task completion or train agents to make direct action decisions through grounding without explicit reasoning processes. This bifurcation results in systems that either lack effective grounding abilities or lack comprehensive reasoning capabilities. Recent approaches attempt to combine closed-source language models with specialized GUI grounding models, communicating via natural language instructions to utilize both capabilities. However, this approach presents two significant limitations: (1) natural language communication between the models frequently results in information loss during transfer, and (2) this approach demonstrates limited scalability for GUI interaction problems. While grounding has approached technical upper bounds through data synthesis techniques, most remaining challenges relate to planning functions. The planning and reasoning capabilities of existing language models remain difficult to enhance for GUI-specific applications.

Embodiments described herein provide a unified vision framework for training GUI agents to generate automatic task executions on GUIs based on vision observation and action spaces across diverse environments of GUIs (e.g., desktop browser GUIs, mobile app GUIs, etc.). Specifically, the training framework includes a first stage of visual grounding training a vision-language model (VLM) based on a dataset of image observations, low-level instructions and atomic actions (e.g., mouse/keyboard movements, etc.). The dataset includes basic GUI operations across platforms including web, desktop, and mobile, which trains the VLM to generate actions in order to control GUI without any action space description. The training framework further moves on to a second stage of reasoning training the VLM using a dataset of “inner monologue” (reasoning for a next action) based on previous actions and observations.

In one embodiment, a data pipeline that unifies existing GUI grounding annotations and integrates explicit planning and reasoning may be built. This enables the construction of large-scale datasets for grounding and multi-step agent trajectory datasets across platforms for training the GUI agent.

In this way, the trained VLM may generate actions to autonomously navigate and interact within complex digital environments while providing a natural language description of reasoning across different platforms. The unified framework effectively addresses the environment heterogeneity challenge by creating a standardized action space that functions across desktop, web, and mobile interfaces. By incorporating basic GUI operations from diverse platforms into a single training dataset, the GUI agent may be trained to generate appropriate actions without requiring environment-specific action space descriptions. This unification significantly enhances cross-platform generalization capabilities and maximizes the utility of available training data, and thus improves training efficiency of GUI agents.

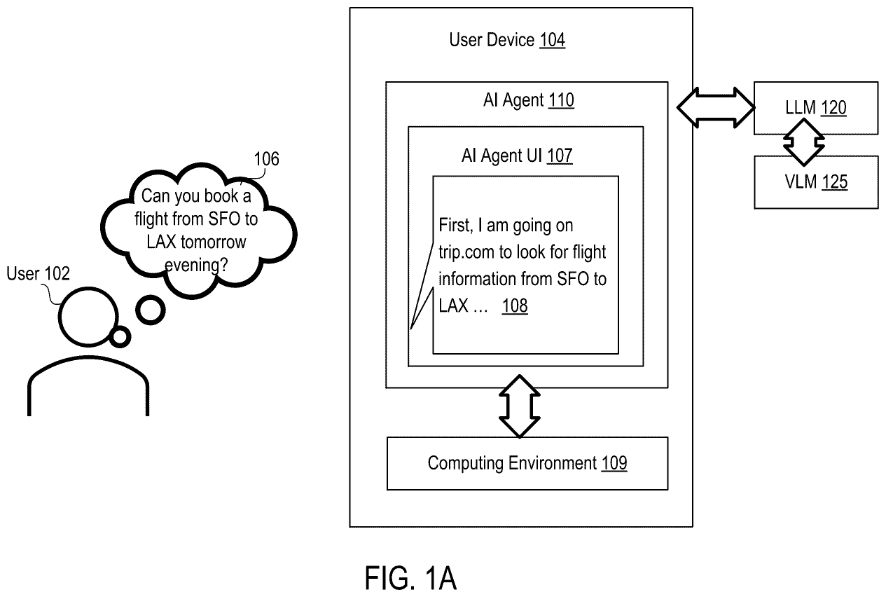

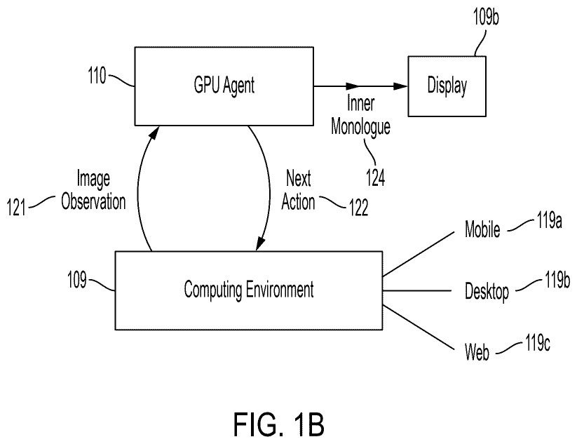

FIG. 1A shows an example operation of an LLM based AI agent, according to embodiments of the present disclosure. An LLM-based AI agent 110 may be implemented on a user device 104 to receive a user task request 106 as a natural language input, typically through a chat or command interface 107. This request 106 may range from simple queries to more complex tasks like data analysis, automation, or even generating content. For example, the user 102 may ask the AI agent to “book a flight from SFO to LAX tomorrow evening” 106.

In one embodiment, the AI agent 110 may processes the task request 106 at an LLM 120 to understand its intent, extracting key information such as the task type, desired outcome, and any specific constraints in order to generate a response. The LLM 120 may be hosted at an external server, a cloud service, and/or the like that is accessible by a communication network. In a different implementation, the LLM 120 may be hosted on the user device 104. An input to the LLM 120 may comprise the task request 106 and instruction provided to the LLM 120 to guide its behavior or responses in a particular way, referred to as a “system prompt.” The LLM 120 may in turn generate a textual response 108 based on an input combining the task request 106 and any system prompt. Additional details on the LLM 120 generating output tokens to form the response 108 may be described in FIG. 5.

The textual response 108 may include instructions, explanations, or direct actions to address the task request 106. Such textual response 108 is displayed via the AI agent interface 107 for transparency. In addition to the textual response 108 that describes how to fulfill the task request, the LLM 120 may generate computer-executable commands (e.g., system-level commands, Python scripts, etc.) that can directly trigger actions and/or interactions with the computing environment 109 on the user device 104.

In some implementations, the AI agent may further adopt a multimodal vision-language module 125, which may be a separate model, or be integrated with LLM 120. The VLM 125 may receive screenshots from the computing environment 109, e.g., a browser application UI so as to extract textual and visual information from each web page. The VLM 125 may then identify key elements such as input fields, labels, and buttons and generate an output indicating where to fill in the form with what information. For example, the VLM 125 may process visual information (such as screenshots of the UI) and text information (such as user provided user name, date of birth, etc., or retrieved profile information from a browser application, etc.) to generate an output code script that fill in the text information into the right fields on a browser UI.

In one implementation, the VLM 125 may comprise an image encoder, such as a vision Transformer, to process input images of arbitrary resolutions by dynamically generating a variable number of visual tokens. To facilitate this functionality, the image encoder may replace absolute position embeddings with two-dimensional rotary position embedding, which captures two-dimensional positional relationships within images. This design allows efficient encoding of high-resolution visuals with reduced image token overhead, making it suitable for GUI agent applications.

For example, when the user 102 requests to book a flight, the LLM 120 and the VLM 125 may output a code script to execute on a browser application on the user device 104 to visit a search website, search for flights from the origin to the destination, navigate the webpages to book the flight, and/or interface with APIs of other applications to automate tasks such as adding the flight information to a calendar application, and/or the like.

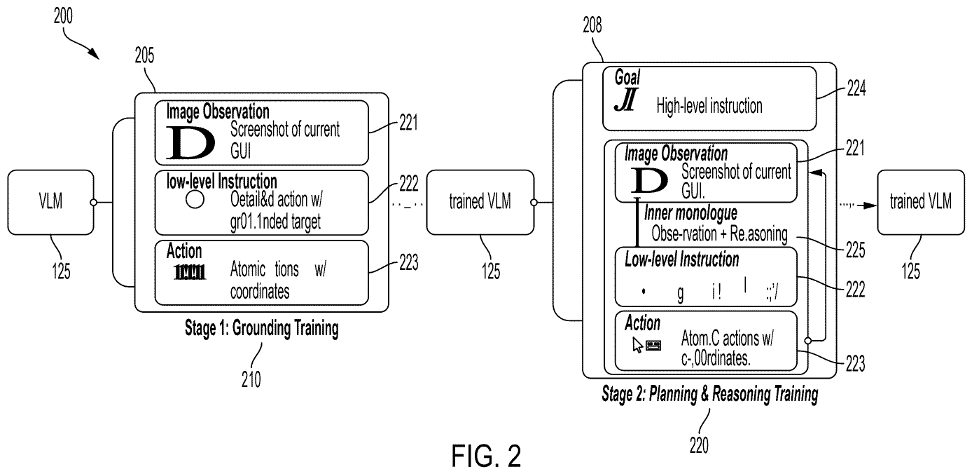

It is noted that the computing environment 109 may include different types of platforms, such as desktop, mobile, browser, and/or other applications. Therefore, the LLM 120 and/or VLM 125 may be trained to generate actions to autonomously navigate and interact within complex digital environments 109, as further illustrated in FIG. 2.

FIG. 1B is a simplified diagram illustrating an example interaction between the GUI agent (e.g., AI agent 110) and the computing environment (e.g., 109), according to embodiments described herein. The interaction between an autonomous GUI agent and its environment can be modeled as a Partially Observable Markov Decision Process (POMDP), defined by the tuple (S, A, O, T, Ω). In this framework, S denotes the set of possible environment states, A is the set of actions available to the agent, and O represents the set of observations the agent can receive. The state transition function T:S×A×S→[0, 1] specifies the probability of transitioning from one state to another, given a particular action. The observation function Ω:S×A×0→[0, 1] defines the probability of receiving a specific observation given a state and an action. This formulation captures the uncertainty and partial observability inherent in GUI-based environments.

At each time step t, the GUI agent 110 receives an image observation oₜ 121 from the GUI environment (e.g., a screenshot, etc.) and generates an inner monologue 124 based on previous actions and observations. The inner monologue 121 consists of three components: a natural language description of the current observation (dₜ), internal reasoning (hₜ) derived from the high-level goal G, the observation description de, and the prior reasoning hₜ₋₁, and a low-level action instruction (a^{nst}) expressed in natural language that specifies the next action. The inner monologue 124 may be displayed at a UI 109b, which may be part of the computing environment 109, or separately from the computing environment 109. The GUI agent 110 may then generate and execute an action aₜ based on a^{nst}, receives a new observation oₜ+1, and iterates this process until the goal G is achieved or a terminal state is reached.

In one embodiment, for observations 121, pure vision eliminates the need to process platform-specific UI source code representations—such as HTML for web or accessibility trees for desktop and mobile—which supports improved generalization across platforms. Additionally, image-based observations reduce input token length compared to structured UI inputs. For example, accessibility trees and HTML can require approximately 6,000 and 4,000 tokens respectively, depending on interface complexity. In contrast, the token cost for image observations is fixed by model configuration, with a 720p input corresponding to approximately 1,200 tokens. In this way, computational overhead for GUI agent 110 to generate a next step action 122 may be significantly reduced.

In one embodiment, the framework unifies the observation and action spaces using image-based observations 121 and pyautogui command-based actions across different platforms such as mobile 119a, desktop 119b, web 119c, and/or the like. For action representation, the framework adopts pyautogui as the standard action space. This Python library allows programmatic simulation of human input (e.g., mouse movements, clicks, and keyboard strokes) and enables the construction of a universal action set for GUI control across web, desktop, and mobile environments. The framework uses these commands to perform basic GUI operations without requiring explicit descriptions of the action space. For example, the pyautogui command-based action space may comprise a set of pre-defined actions of pyautogui.moveTo(x, y), pyautogui.click(x, y), pyautogui.write(‘text’), pyautogui.press(‘enter’), pyautogui.hotkey(‘ctrl’, ‘c’), pyautogui.scroll(200), pyautogui.dragTo(x, y), and/or the like.

To handle platform-specific or advanced actions not natively supported by pyautogui, a pluggable action system is introduced. This system supports additional functionalities such as mobile swipes, shortcut-based operations, and communication actions (e.g., submitting responses or terminating tasks). New actions are either aligned with existing pyautogui commands or integrated with detailed descriptions when no direct mapping exists. This design supports extensibility and allows the model to generalize to novel tasks and interfaces. The integration of pure vision observations, a unified command space, and an extensible action interface enables training a single agent model capable of operating across heterogeneous digital environments. Additional example pluggable actions may comprise browser.select option(x, y, value), mobile.swipe(from, to), mobile.home( ), mobile.back( ), mobile.open app(name), terminate(status), answer(text), and/or the like.

In one embodiment, an example prompt to the GUI agent 110 to perform an action on a mobile environment may take a form similar to:
You are a GUI agent. You are given a task and a screenshot of the screen. You need to perform a series of pyautogui actions to complete the task.
You have access to the following functions:

- {“name”: “mobile.home”, “description”: “Press the home button”}
- {“name”: “mobile.back”, “description”: “Press the back button”}
- {
“name”: “mobile.long_press”,
“description”: “Long press on the screen”,
“parameters”: {
“type”: “object”,
“properties”: {“x”: {“type”: “number”, “description”: “The
x coordinate of the long press”}, “y”: {“type”: “number”,
“description”: “The y coordinate of the long press”}},
“required”: [“x”, “y”]
}
}
- {
“name”: “mobile.open_app”,
“description”: “Open an app on the device”,
“parameters”: {
“type”: “object”,
“properties”: {“app_name”: {“type”: “string”,
“description”: “The name of the app to open”}},
“required”: [“app_name”]
}
}
- {
“name”: “terminate”,
“description”: “Terminate the current task and report its
completion status”,
“parameters”: {
“type”: “object”,
“properties”: {“status”: {“type”: “string”, “enum”:
[“success”], “description”: “The status of the task”}},
“required”: [“status”]
}
}
-{
“name”: “answer”,
“description”: “Answer a question”, “parameters”: {
“type”: “object”,
“properties”: {“answer”: {“type”: “string”, “description”:
“The answer to the question”}},
“required”: [“answer”]
}
}

FIG. 2 is a simplified diagram illustrating a training framework for the GUI agent (e.g., similar to AI agent 110 in FIG. 1), according to some embodiments. The GUI agent may be built upon the LLM 120 and/or VLM 125 in FIG. 1. Two stages of training may be implemented for training the VLM: Grounding Training 210 and Planning & Reasoning Training 220.

For example, at stage 1 of Grounding Training 210, the VLM 125 may be trained to interact with objects within a single GUI screenshot, using a dataset 205 of screenshots 221 of GUIs, low-level instructions 222 (e.g., detailed action with intended target, etc.), atomic actions 223 with coordinates, and/or the like. Given a training GUI screenshot as input, the VLM 125 may generate precise (x,y) coordinate pairs indicating where on the screen to execute actions such as clicks, double-clicks, or long presses, action commands indicating what type of action to perform at the identified coordinates, such as CLICK (x,y), TYPE “text string” SCROLL UP/DOWN/LEFT/RIGHT, DRAG FROM (x1,y1) TO (x2,y2), HOVER (x,y), and/or the like. The generated coordinates and/or action commands may then be compared to the ground-truth coordinates and/or actions from the training dataset to compute a gradient for updating the VLM 125.

Or additionally, given a textual instruction (e.g., “click the submit button”) from the training dataset, the VLM 125 may identify which visual elements on a screen (buttons, text fields, icons, etc.) correspond to a given textual instruction, determine the precise spatial coordinates of these elements to enable interaction, and/or understanding the relationship between visual elements and their functions within the interface, map natural language commands to specific visual targets that need to be manipulated, and/or the like. The VLM predicted coordinates of the “submit button” and/or the predicted action commands may then be compared with the ground-truth coordinates and action commands from the dataset to compute a gradient for updating the VLM 125.

In one embodiment, GUI environments often feature multiple interactable objects within a single screenshot, generating a large volume of grounding data, which can limit training efficiency. Instead, the VLM 125 may be trained with a grounding packing strategy where multiple instruction-action pairs are bundled with a single GUI screenshot image, resulting in a single-image-multiple-turn format for the training data. For example, a screenshot of a browser page of a search engine may be paired with instruction-action sequence for locating the search term field, entering the search term, and pressing the “search” button. The screenshot of the same search engine webpage may be paired with another instruction-action sequence for locating the “video” option, clicking the “video” button,” locating the search term field, entering the search term, and/or the like. This technique allows the VLM 125 to be trained by several grounding examples from one single GUI screenshot, reducing redundant training overhead while retaining a high level of grounding performance. In this way, training efficiency may be significantly accelerated by maximizing the use of each GUI screenshot image without compromising accuracy.

In one embodiment, an example training data schema of stage 1 training may take a form similar to:

Prompt
<|im_start|>system
You are a GUI agent. You are given a task and a screenshot of the
screen. You need to perform a series of pyautogui actions to
complete the task.<|im_end|>
<|im_start|>user
<|vision_start|><|image_pad|><|vision_end|>
Please generate the next move according to the ui screenshot,
instruction and previous actions.
Instruction: {overall_goal}
Previous actions: {previous_actions}
<|im_end|>
Generation
<|im_start|>assistant<|recipient|>os
Action: {pyautogui function}
<|diff_marker|>

In one embodiment, the trained VLM may proceed to stage 2 training 220 to train the VLM 125 to generate planning & reasoning data. The VLM 125 may be trained to execute multi-step tasks by generating reasoning data (“inner monologue”) through agent trajectories that vary in complexity and environments, encompassing diverse reasoning modes. For example, the training dataset 208 may include GUI trajectories including a high-level instruction 208, image observations 221 (e.g., screenshots of current GUI, an inner monologue 225 of the observation and the reasoning, and low-level instruction 222 (e.g., detailed action with grounded targeted) and atomic actions 223 with coordinates, and/or the like. An example GUI trajectory in response to the user request of “book a flight from New York to London for next Monday” may take a form similar to:
HIGH-LEVEL INSTRUCTION: “Book a flight from New York to London for next Monday”
IMAGE_OBSERVATION: [Screenshot of travel booking website homepage]
INNER_MONOLOGUE: “I can see this is a travel booking website with a search form at the center. There are fields for departure city, destination city, and date selection. I need to first click on the departure city field and enter ‘New York’, then select the destination as ‘London’, and finally set the date to next Monday before searching for flights.”
LOW-LEVEL_INSTRUCTION: “Click on the departure city input field”
ATOMIC_ACTION: CLICK(215,340)
IMAGE_OBSERVATION: [Screenshot showing departure city field active with cursor]
INNER_MONOLOGUE: “The departure field is now active. I need to type ‘New York’ to specify the departure city.”
LOW-LEVEL_INSTRUCTION: “Type ‘New York’ in the departure field”
ATOMIC_ACTION: TYPE (“New York”)
IMAGE_OBSERVATION: [Screenshot showing “New York” entered in departure field]
INNER_MONOLOGUE: “New York has been entered as the departure city. Now I need to click on the destination field to enter London.”
LOW-LEVEL_INSTRUCTION: “Click on the destination city input field”
ATOMIC_ACTION: CLICK(215,395)

In this way, the VLM 125 may be trained on the GUI trajectories to learn how to process a high-level task by breaking it down into a sequence of observations, reasoning steps, and precise actions. Each atomic action is grounded to specific coordinates on the screen, while the inner monologue reveals the agent's reasoning process and understanding of the GUI state.

For example, during stage 2 training, the VLM 125 may receive a sequence containing the high-level instruction, current screenshot, and action history up to a given point. The VLM 125 may then predict the next components in the trajectory: the inner monologue reasoning and the corresponding atomic action. This process may employ a teacher-forcing methodology where the VLM 125 may generate appropriate reasoning about the visual elements in the screenshot, followed by precise low-level instructions and coordinate-based actions. The training objective may combine multiple loss functions: one comparing predicted inner monologue text and the ground-truth inner monologue reasoning from the training dataset, one loss comparing the predicted coordinates on the GUI screenshot and predicted action types needed to interact with the correct interface elements and the ground-truths from the training dataset. Through iterative exposure to diverse GUI trajectories across different interfaces and tasks, the VLM 125 may be updated.

With various training GUI trajectories of varying complexity on different computing platforms, the VLM 125 is trained to be adaptable, fostering step-by-step reasoning and high-level decision-making abilities.

In one embodiment, an example training data schema of stage 2 training may take a form similar to:

Prompt
<|im_start|>system
You are a GUI agent. You are given a task and a screenshot of the
screen. You need to perform a series of pyautogui actions to
complete the task.<|im_end|>
<|im_start|>user
<|vision_start|><|image_pad|><|vision_end|>
Please generate the next move according to the ui screenshot,
instruction and previous actions.
Instruction: {overall_goal}
Previous actions: {previous_actions}
<|im_end|>
Generation
<|im_start|>assistant<|recipient|>all
Observation: {Observation}
Thought: {Planning}
Low-level Instruction: {Low-level Instruction}
<|im_end|>
<|im_start|>assistant<|recipient|>os
Action: {pyautogui function}
<|diff_marker|>

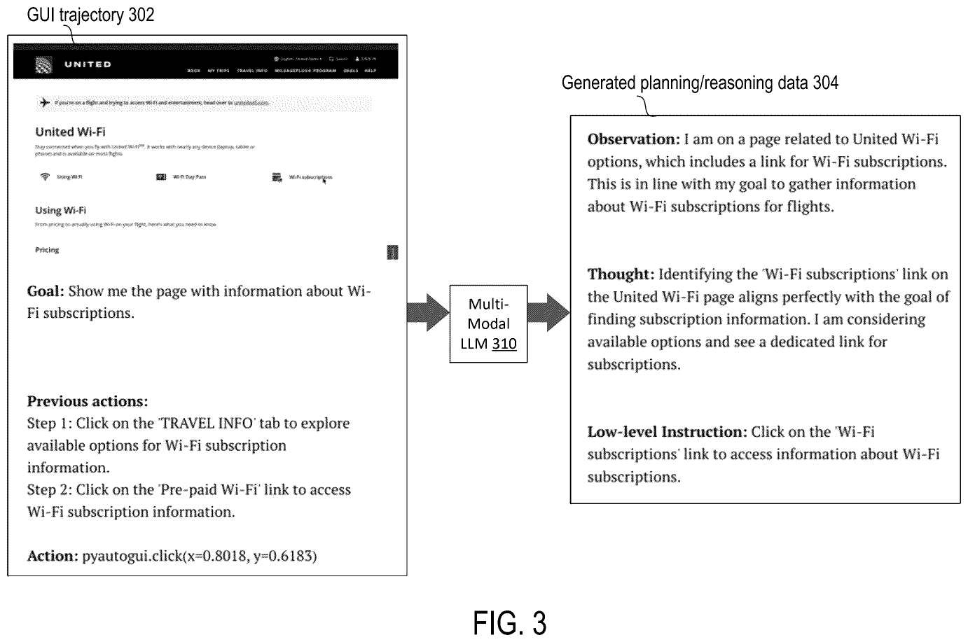

FIG. 3 is a simplified diagram illustrating a data generation pipeline to generating training data for the training framework shown in FIG. 2, according to some embodiments. In one embodiment, GUI agent trajectories may be resource-constrained due to significant variations in observation and action spaces across different environments, even within identical platforms. However, as some GUI environments may share similar operational logic and action space, training dataset may be expanded. For example, through grounding split (Table 1) and planning/reasoning split (Table 11), GUI agent trajectories may be augmented into the training data across different computing platforms.

In one embodiment, training data of vision-based grounding may be generated via template based augmentation. Vision-based grounding requires the VLM 125 to align natural language intent with precise coordinates on image observations. Multiple datasets containing natural language instructions and corresponding target elements across multiple platforms may be obtained and unified into a standardized pyautogui commands format. Additionally, numerous user interface datasets from diverse platforms contain extensive metadata, including positional information for text elements, icons, and widgets within interfaces may be obtained. This metadata may enable template construction for generating pyautogui actions. Through these templates, grounding data pairs are randomly generated to train the VLM 125 in element localization based on image inputs. This methodical template-based approach significantly expands the available training data scale, providing more comprehensive coverage of potential grounding scenarios across various interface types.

In one embodiment, a multi-modal LLM 310 (e.g., GPT-4o) may be used to augment planning and/or reasoning GUI trajectories. For example, high-quality GUI agent trajectories may include a high-level task objective, a sequence of interleaved observations, natural language reasoning steps, and corresponding grounded actions. Existing datasets used for training such GUI agents are generally collected through human annotation and primarily include the task goal, environmental observations, and the final grounded actions. However, many of these datasets do not contain intermediate reasoning or low-level action instructions that articulate how each action was determined. The absence of such reasoning components limits the ability to train agents that can perform chain-of-thought or inner monologue-style planning, which in turn impacts the effectiveness of action sequencing and overall task execution.

In one embodiment, a multi-modal LLM 310 may generate inner monologue components for each step within a GUI agent trajectory. For example, at each time step t, the multi-modal LLM 310 is provided with a GUI trajectory 302, e.g., from an existing dataset, including the high-level goal G, the current image observation oₜ, and the grounded action aₜ. Using this information, the multi-modal LLM 310 may generate the planning/reasoning data 304 including: a natural language description of the observation dₜ, a reasoning step or thought hₜ, and a corresponding low-level action instruction aᵢₙₛₜᵣₜ. To guide the multi-modal LLM's attention toward the relevant region of the interface, a visual cue is applied to the image observation oₜ by highlighting the interface element associated with the grounded action aₜ. Furthermore, the multi-modal LLM 310 is supplied with a sequence of previous low-level action instructions (aᵢₙₛₜᵣ₁, aᵢₙₛₜᵣ₂, . . . , aᵢₙₛₜᵣₜ₋₁) to maintain coherence and contextual awareness in the monologue generation process.

In one embodiment, the multi-modal LLM 310 may be provided a prompt in generating inner monologue components that are predictive and aligned with task objectives, while avoiding reliance on future actions or hindsight. The prompt may simulate an agent's step-by-step reasoning from a first-person perspective, enabling the generation of intermediate thoughts and low-level instructions based on the high-level goal and current observation. An example prompt used for guiding the multi-modal LLM 310 may take a format similar to:

Goal: {goal}
Previous Actions: {previous_actions}
Given the current screenshot and the next ground truth action
labeled as ‘{current_action_instruction}‘, the action commands is:
‘‘‘json
{action_commands}
‘‘‘

This element is highlighted in red bounding box in the image.
Describe the situation in detail, focusing on the goal and current observation. Ensure your reasoning aligns with the goal and the labeled action, but avoid using the labeled action or the highlighted bounding box as reasoning support, as they represent hindsight rather than predictive insight. Conclude with a clear, actionable instruction in one sentence. Aim to reason through the task as if solving it, rather than simply reflecting on the labeled outcome. Use the first-person perspective to represent the annotator's thought process.

### Computer and Network Environment

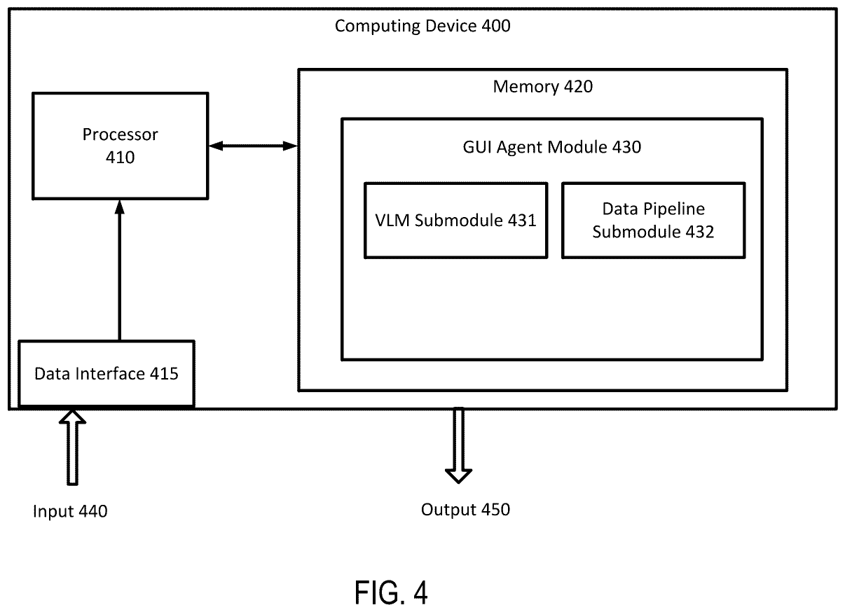

FIG. 4 is a simplified diagram illustrating a computing device implementing the GUI agent described in FIG. 1, according to one embodiment described herein. As shown in FIG. 4A, computing device 400 includes a processor 410 coupled to memory 420. Operation of computing device 400 is controlled by processor 410. And although computing device 400 is shown with only one processor 410, it is understood that processor 410 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 400. Computing device 400 may be implemented as a stand-alone subsystem, as a board added to a computing device, and/or as a virtual machine.

Memory 420 may be used to store software executed by computing device 400 and/or one or more data structures used during operation of computing device 400. Memory 420 may include one or more types of machine-readable media. Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 410 and/or memory 420 may be arranged in any suitable physical arrangement. In some embodiments, processor 410 and/or memory 420 may be implemented on a same board, in a same package (e.g., system-in-package), on a same chip (e.g., system-on-chip), and/or the like. In some embodiments, processor 410 and/or memory 420 may include distributed, virtualized, and/or containerized computing resources. Consistent with such embodiments, processor 410 and/or memory 420 may be located in one or more data centers and/or cloud computing facilities.

In another embodiment, processor 410 may comprise multiple microprocessors and/or memory 420 may comprise multiple registers and/or other memory elements such that processor 410 and/or memory 420 may be arranged in the form of a hardware-based neural network, as further described in FIG. 3.

In some examples, memory 420 may include non-transitory, tangible, machine readable media that includes executable code that when run by one or more processors (e.g., processor 410) may cause the one or more processors to perform the methods described in further detail herein. For example, as shown, memory 420 includes instructions for GUI agent module 430 that may be used to implement and/or emulate the systems and models, and/or to implement any of the methods described further herein. GUI agent module 430 may receive input 440 such as an input training data (e.g., sequences of instructions and executions on GUIs) via the data interface 415 and generate an output 450 which may be an execution on a GUI page.

The data interface 415 may comprise a communication interface, a user interface (such as a voice input interface, a graphical user interface, and/or the like). For example, the computing device 400 may receive the input 440 (such as a training dataset) from a networked database via a communication interface. Or the computing device 400 may receive the input 440, such as a GUI screenshot, from a user via the user interface.

In some embodiments, the GUI agent module 430 is configured to generate a series of GUI executions. The GUI agent module 430 may further include a VLM submodule 431 and/or a data pipeline submodule 432.

Some examples of computing devices, such as computing device 400 may include non-transitory, tangible, machine readable media that include executable code that when run by one or more processors (e.g., processor 410) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

FIG. 5 is a simplified diagram illustrating the neural network structure implementing the GUI agent module 430 described in FIG. 4, according to some embodiments. In some embodiments, the GUI agent module 430 and/or one or more of its submodules 431-232 may be implemented at least partially via an artificial neural network structure shown in FIG. 4B. The neural network comprises a computing system that is built on a collection of connected units or nodes, referred to as neurons (e.g., 444, 445, 446). Neurons are often connected by edges, and an adjustable weight (e.g., 451, 452) is often associated with the edge. The neurons are often aggregated into layers such that different layers may perform different transformations on the respective input and output transformed input data onto the next layer.

For example, the neural network architecture may comprise an input layer 441, one or more hidden layers 442 and an output layer 443. Each layer may comprise a plurality of neurons, and neurons between layers are interconnected according to a specific topology of the neural network topology. The input layer 441 receives the input data (e.g., 440 in FIG. 4A),. The number of nodes (neurons) in the input layer 441 may be determined by the dimensionality of the input data (e.g., the length of a vector of a feature of a GUI representation). Each node in the input layer represents a feature or attribute of the input.

The hidden layers 442 are intermediate layers between the input and output layers of a neural network. It is noted that two hidden layers 442 are shown in FIG. 4B for illustrative purpose only, and any number of hidden layers may be utilized in a neural network structure. Hidden layers 442 may extract and transform the input data through a series of weighted computations and activation functions.

For example, as discussed in FIG. 4, the GUI agent module 430 receives an input 440 of a GUI screenshot and transforms the input into an output 450 of a GUI execution. To perform the transformation, each neuron receives input signals, performs a weighted sum of the inputs according to weights assigned to each connection (e.g., 451, 452), and then applies an activation function (e.g., 461, 462, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 441 is transformed into rather different values indicative data characteristics corresponding to a task that the neural network structure has been designed to perform.

The output layer 443 is the final layer of the neural network structure. It produces the network's output or prediction based on the computations performed in the preceding layers (e.g., 441, 442). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the GUI agent module 430 and/or one or more of its submodules 431-232 may comprise the transformative neural network structure of layers of neurons, and weights and activation functions describing the non-linear transformation at each neuron. Such a neural network structure is often implemented on one or more hardware processors 410, such as a graphics processing unit (GPU). An example neural network may be a Transformer based multimodal LLM, and/or the like.

In one embodiment, the GUI agent module 430 and its submodules 431-232 may comprise one or more LLMs built upon a Transformer architecture. For example, the Transformer architecture comprises multiple layers, each consisting of self-attention and feedforward neural networks. The self-attention layer transforms a set of input tokens (such as words) into different weights assigned to each token, capturing dependencies and relationships among tokens. The feedforward layers then transform the input tokens, based on the attention weights, represents a high-dimensional embedding of the tokens, capturing various linguistic features and relationships among the tokens. The self-attention and feed-forward operations are iteratively performed through multiple layers of self-attention and feedforward layers, thereby generating an output based on the context of the input tokens. One forward pass for an input tokens to be processed through the multiple layers to generate an output in a Transformer architecture often entail hundreds of teraflops (trillions of floating-point operations) of computation.

For example, the Transformer-based architecture may process an input sequence of tokens (e.g., letters, symbols, numbers, signs, words, etc.) using its encoder-decoder architecture (for tasks such as machine translation, etc.) or just the encoder (for classification tasks) or decoder (for generation-only tasks). First, the input sequence may be tokenized and converted into embeddings, which are dense numerical representations, e.g., vectors of values. Positional encodings are added to these embeddings to provide information about the order of tokens.

The Transformer encoder, usually consisting of multiple layers, each of which may processes the input using a multi-head self-attention mechanism to capture relationships between tokens and a feed-forward network to transform the information, resulting in encoded representations of the input sequence of tokens.

For example, the multi-head self-attention mechanism at each Transformer layer within the Transformer encoder of an LLM may project input embeddings at the layer into three different embedding spaces using weight matrices, referred to as Query (Q) representing what a token wants to attend to, Key (K) representing what this token offers as information and Value (V) representing the actual information carried by the token. The Q K, V matrices contain tunable weights of a Transformer-based language model that are updated during training. Then, the attention mechanism computes attention scores between all tokens in the input sequence using the Q, K and V matrices. The resulting attention scores are then used to generate encoded representations of the input sequence of tokens.

Similarly, the Transformer decoder may comprise a symmetric structure with the encoder, consisting of multiple layers, each of which may comprise a multi-head self-attention mechanism. The decoder may start with a special start token and use the multi-head self-attention mechanism, augmented with encoder-decoder attention to focus on relevant parts of the decoder input. The decoder may generate output tokens one by one, with each step using the previously generated tokens as part of the input and updated attention weights. Finally, the decoder may comprise a linear layer and softmax function predict probabilities for the next token in the sequence, selecting the most likely one to continue the output. This process repeats until a special end token is generated or a length limit is reached.

The generated sequence of tokens may jointly represent an output. For example, a Transformer-based LLM (such as LLM 110a-d) may receive a natural language input (such as a question) and generate a natural language output (such as an answer to the question).

In one embodiment, the GUI agent module 430 and its submodules 431-232 may be implemented by hardware, software and/or a combination thereof. For example, the GUI agent module 430 and its submodules 431-232 may comprise a specific neural network structure implemented and run on various hardware platforms 460, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 460 used to implement the neural network structure is specifically configured based on factors such as the complexity of the neural network, the scale of the tasks (e.g., training time, input data scale, size of training dataset, etc.), and the desired performance.

For example, to deploy the GUI agent module 430 and its submodules 431-432 and/or any other neural network models such as VLM 125 described in FIGS. 1A-3 onto hardware platform 460, the neural network based modules 430 and its submodules 431-432 may be optimized for deployment by converting it to a suitable format, such as ONNX or TensorRT, to improve performance and compatibility. Next, depending on the size and workload requirements for modules 430 and its submodules 431-432, hardware types may be chosen for deployment, e.g., processing capacity, GPU memory size, and/or the like. Frameworks and drivers for the chosen hardware 460 frameworks and drivers may thus be installed, such as PyTorch, TensorFlow, or CUDA, to support the hardware platform 460. Then, weights and parameters of the GUI agent module 430 and its submodules 431-432 may be loaded to the hardware 460. For large-scale deployments (e.g., with billions of weights for example), distributed computing frameworks may be used to handle model partitioning across multiple devices, e.g., hardware processors such as GPUs may be distributed on multiple devices, each handling a portion of weights of the model and therefore would undertake a portion of computational workload. In some embodiments, the GUI agent module 430 and its submodules 431-432 may be deployed as a service, then they may be integrated with an API endpoint, using tools like Flask, FastAPI, or a cloud platform serverless services, and is accessible by a remote user via a network.

In another embodiment, some or all of layers 441, 442, 443 and/or neurons 442, 445, 446, and operations there between such as activations 461, 462, and/or the like, of the GUI agent module 430 and its submodules 431-232 may be realized via one or more ASICs. For example, each neuron 442, 445 and 446 may be a hardware ASIC comprising a register, a microprocessor, and/or an input/output interface. For another example, operations among the neurons and layers may be implemented through an ASIC TPU. For yet another example, some operations among the neurons and layers such as a softmax operation, an activation function (such as a rectified linear unit (ReLU), sigmoid linear unit (SiLU), and/or the like) may be implemented by one or more ASICs.

For example, the GUI agent module 430 may generate, by at least one ASIC (such as a TPU, etc.) performing a multiplicative and/or accumulative operation for a neural network language model, a next token based at least in prat on previously generated tokens, and in turn generate a natural language output representing the next-step action combining a sequence of generated tokens.

In one embodiment, the neural network based GUI agent module 430 and one or more of its submodules 431-232 may be trained by iteratively updating the underlying parameters (e.g., weights 451, 452, etc., bias parameters and/or coefficients in the activation functions 461, 462 associated with neurons) of the neural network based on the loss. For example, during forward propagation, the training data such as sequences of GUI executions are fed into the neural network. The data flows through the network's layers 441, 442, with each layer performing computations based on its weights, biases, and activation functions until the output layer 443 produces the network's output 450. In some embodiments, output layer 443 produces an intermediate output on which the network's output 450 is based.

The output generated by the output layer 443 is compared to the expected output (e.g., a “ground-truth” such as the corresponding GUI execution sequences for a set of GUI pages) from the training data, to compute a loss function that measures the discrepancy between the predicted output and the expected output. For example, the loss function may be cross entropy, MMSE, and/or the like. Given the loss, the negative gradient of the loss function is computed with respect to each weight of each layer individually. Such negative gradient is computed one layer at a time, iteratively backward from the last layer 443 to the input layer 441 of the neural network. These gradients quantify the sensitivity of the network's output to changes in the parameters. The chain rule of calculus is applied to efficiently calculate these gradients by propagating the gradients backward from the output layer 443 to the input layer 441.

In one embodiment, the neural network based GUI agent module 430 and one or more of its submodules 431-232 may be trained using policy gradient methods, also referred to as “reinforcement learning” methods. For example, instead of computing a loss based on a training output generated via a forward propagation of training data, the “policy” of the neural network model, which is a mapping from an input of the current states or observations of an environment the neural network model is operated at, to an output of action. Specifically, at each time step, a reward is allocated to an output of action generated by the neural network model. The gradients of the expected cumulative reward with respect to the neural network parameters are estimated based on the output of action, the current states of observations of the environment, and/or the like. These gradients guide the update of the policy parameters using gradient descent methods like stochastic gradient descent (SGD) or Adam. In this way, as the “policy” parameters of the neural network model may be iteratively updated while generating an output action as time progresses, the boundaries between training and inference are often less distinct compared to supervised learning—in other words, backward propagation and forward propagation may occur for both “training” and “inference” stages of the neural network mode.

In one embodiment, GUI agent module 430 and its submodules 431-232 may be housed at a centralized server (e.g., computing device 400) or one or more distributed servers. For example, one or more of GUI agent module 430 and its submodules 431-232 may be housed at external server(s). The different modules may be communicatively coupled by building one or more connections through application programming interfaces (APIs) for each respective module. Additional network environment for the distributed servers hosting different modules and/or submodules may be discussed in FIG. 4.

During a backward pass, parameters of the neural network are updated backwardly from the last layer to the input layer (backpropagating) based on the computed negative gradient using an optimization algorithm to minimize the loss. The backpropagation from the last layer 443 to the input layer 441 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as automatic video gaming.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

In some implementations, to improve the computational efficiency of training a neural network model, “training” a neural network model such as an LLM may sometimes be carried out by updating the input prompt, e.g., the instruction to teach an LLM how to perform a certain task. For example, while the parameters of the LLM may be frozen, a set of tunable prompt parameters and/or embeddings that are usually appended to an input to the LLM may be updated based on a training loss during a backward pass. For another example, instead of tuning any parameter during a backward pass, input prompts, instructions, or input formats may be updated to influence their output or behavior. Such prompt designs may range from simple keyword prompts to more sophisticated templates or examples tailored to specific tasks or domains.

In general, the training and/or finetuning of an LLM can be computationally extensive. For example, GPT-3 has 175 billion parameters, and a single forward pass using an input of a short sequence can involve hundreds of teraflops (trillions of floating-point operations) of computation. Training such a model requires immense computational resources, including powerful GPUs or TPUs and significant memory capacity. Additionally, during training, multiple forward and backward passes through the network are performed for each batch of data (e.g., thousands of training samples), further adding to the computational load.

In general, the training process transforms the neural network into an “updated” trained neural network with updated parameters such as weights, activation functions, and biases. The trained neural network thus improves neural network technology in AI agent.

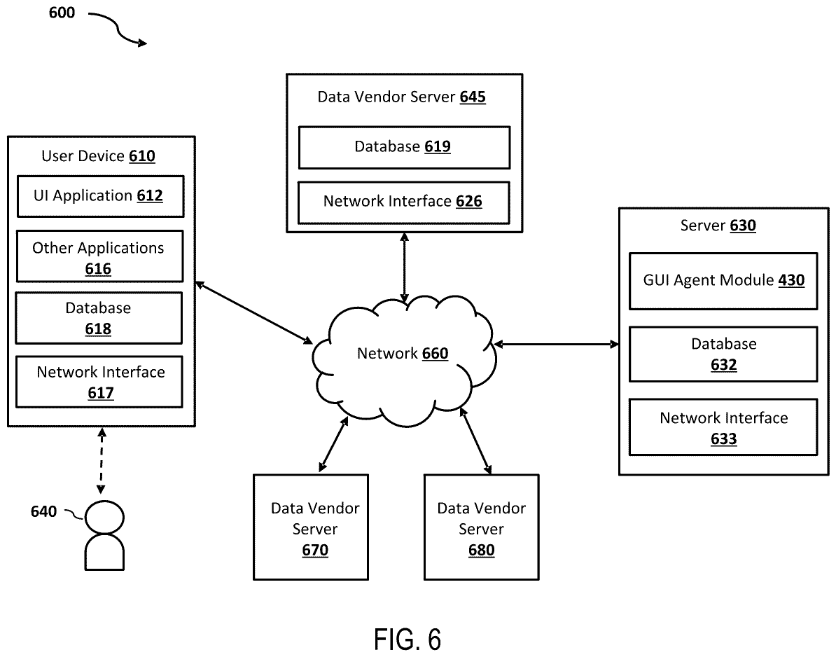

FIG. 6 is a simplified block diagram of a networked system 600 suitable for implementing the GUI agent framework described in FIGS. 1-3 and other embodiments described herein. In one embodiment, system 600 includes the user device 610 which may be operated by user 640, data vendor servers 645, 670 and 680, server 630, and other forms of devices, servers, and/or software components that operate to perform various methodologies in accordance with the described embodiments. Exemplary devices and servers may include device, stand-alone, and enterprise-class servers which may be similar to the computing device 200 described in FIG. 2A, operating an OS such as a MICROSOFT® OS, a UNIX® OS, a LINUX® OS, or other suitable device and/or server-based OS. It can be appreciated that the devices and/or servers illustrated in FIG. 6 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities.

The user device 610, data vendor servers 645, 670 and 680, and the server 630 may communicate with each other over a network 660. User device 610 may be utilized by a user 640 (e.g., a driver, a system admin, etc.) to access the various features available for user device 610, which may include processes and/or applications associated with the server 630 to receive an output data anomaly report.

User device 610, data vendor server 645, and the server 630 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 600, and/or accessible over network 660.

User device 610 may be implemented as a communication device that may utilize appropriate hardware and software configured for wired and/or wireless communication with data vendor server 645 and/or the server 630. For example, in one embodiment, user device 610 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 610 of FIG. 6 contains a user interface (UI) application 612, and/or other applications 616, which may correspond to executable processes, procedures, and/or applications with associated hardware. For example, the user device 610 may receive a message indicating a demonstration of GUI execution from the server 630 and display the message via the UI application 612. In other embodiments, user device 610 may include additional or different modules having specialized hardware and/or software as required.

In one embodiment, UI application 612 may communicatively and interactively generate a UI for an AI agent implemented through the GUI agent module 230 (e.g., an LLM agent) at server 630. In at least one embodiment, a user operating user device 610 may enter a user utterance, e.g., via text or audio input, such as a question, uploading a document, and/or the like via the UI application 612. Such user utterance may be sent to server 630, at which GUI agent module 230 may generate a response via the process described in FIGS. 1-3. The GUI agent module 230 may thus cause a display of exemplary GUI execution results at UI application 612 and interactively update the display in real time with the user utterance.

In various embodiments, user device 610 includes other applications 616 as may be desired in particular embodiments to provide features to user device 610. For example, other applications 616 may include security applications for implementing client-side security features, programmatic client applications for interfacing with appropriate application programming interfaces (APIs) over network 660, or other types of applications. Other applications 616 may also include communication applications, such as email, texting, voice, social networking, and IM applications that allow a user to send and receive emails, calls, texts, and other notifications through network 660. For example, the other application 616 may be an email or instant messaging application that receives a prediction result message from the server 630. Other applications 616 may include device interfaces and other display modules that may receive input and/or output information. For example, other applications 616 may contain software programs for asset management, executable by a processor, including a graphical user interface (GUI) configured to provide an interface to the user 640 to view GUI execution results.

User device 610 may further include database 618 stored in a transitory and/or non-transitory memory of user device 610, which may store various applications and data and be utilized during execution of various modules of user device 610. Database 618 may store user profile relating to the user 640, predictions previously viewed or saved by the user 640, historical data received from the server 630, and/or the like. In some embodiments, database 618 may be local to user device 610. However, in other embodiments, database 618 may be external to user device 610 and accessible by user device 610, including cloud storage systems and/or databases that are accessible over network 660.

User device 610 includes at least one network interface component 617 adapted to communicate with data vendor server 645 and/or the server 630. In various embodiments, network interface component 617 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data vendor server 645 may correspond to a server that hosts database 619 to provide training datasets including to the server 630. The database 619 may be implemented by one or more relational database, distributed databases, cloud databases, and/or the like.

The data vendor server 645 includes at least one network interface component 626 adapted to communicate with user device 610 and/or the server 630. In various embodiments, network interface component 626 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices. For example, in one implementation, the data vendor server 645 may send asset information from the database 619, via the network interface 626, to the server 630.

The server 630 may be housed with the GUI agent module 230 and its submodules described in FIG. 2A. In some implementations, GUI agent module 230 may receive data from database 619 at the data vendor server 645 via the network 660 to generate GUI executions. The generated GUI execution results may also be sent to the user device 610 for review by the user 640 via the network 660.

In one embodiment, an AI agent implementing the GUI agent module 430 and its submodules described in FIG. 4A may be built based on an LLM as described in FIG. 4B. For example, the AI agent may be configured with one or more LLMs (e.g., each pretrained for a specific task or domain), a plurality of system prompts, and connected to external APIs to databases and applications (e.g., a search engine, a cloud service, an internal database, etc.).

In some embodiments, the AI agent implementing the GUI agent module 430 and its submodules described in FIG. 4A may be implemented as a cloud-based AI agent which may be accessed by user device 610 via a chatbot application, a web application, customer support or SaaS applications. In another implementation, a client-side AI agent component may be delivered from the server 630 to user device 610 for local installation such that the client-side AI agent may be installed and runs directly on the user's device. Such local AI agent on the user device 610 may be available offline to adapt to privacy-sensitive applications. In another implementation, the AI agent implementing the GUI agent module 430 and its submodules described in FIG. 4A may adopt a hybrid cloud and client-based structure to balance computing speed, cost and privacy. For example, a local AI agent may handle basic AI queries locally, but complex queries may be sent to server 630 to process.

The database 632 may be stored in a transitory and/or non-transitory memory of the server 630. In one implementation, the database 632 may store data obtained from the data vendor server 645. In one implementation, the database 632 may store parameters of the GUI agent module 230. In one implementation, the database 632 may store previously generated GUI executions, and the corresponding input feature vectors.

In some embodiments, database 632 may be local to the server 630. However, in other embodiments, database 632 may be external to the server 630 and accessible by the server 630, including cloud storage systems and/or databases that are accessible over network 660.

The server 630 includes at least one network interface component 633 adapted to communicate with user device 610 and/or data vendor servers 645, 670 or 680 over network 660. In various embodiments, network interface component 633 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 660 may be implemented as a single network or a combination of multiple networks. For example, in various embodiments, network 660 may include the Internet or one or more intranets, landline networks, wireless networks, and/or other appropriate types of networks. Thus, network 660 may correspond to small scale communication networks, such as a private or local area network, or a larger scale network, such as a wide area network or the Internet, accessible by the various components of system 600.

### Example Work Flows

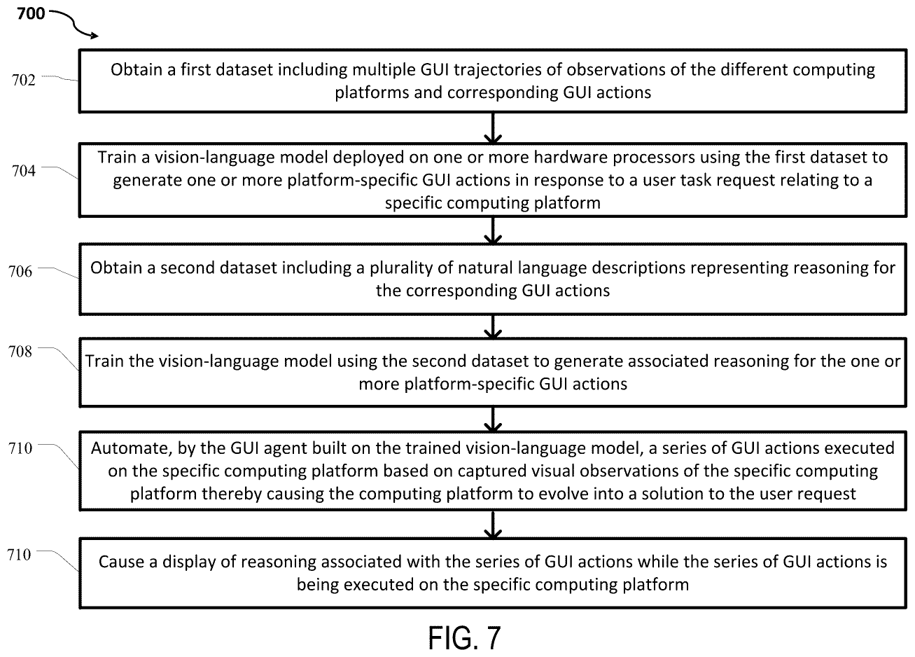

FIG. 7 is an example logic flow diagram illustrating a method of building a GUI agent to automate tasks across different computing platforms based on the framework shown in FIGS. 1A-6, according to some embodiments described herein. One or more of the processes of method 700 may be implemented, at least in part, in the form of executable code stored on non-transitory, tangible, machine-readable media that when run by one or more processors may cause the one or more processors to perform one or more of the processes. In some embodiments, method 700 corresponds to the operation of the GUI agent module 430 (e.g., FIGS. 4 and 6) that performs automating tasks across different computing platforms.

In some embodiments, method 700 is performed by a system such as computing device 400, user device 610, server 630, or another device or combination of devices. Inputs (e.g., a user task request) may be received via a data interface such as data interface 415, network interface 617, network interface 633, or via a data interface that is integrated with a device. For example UI Application 612 may receive user inputs via a text input interface (e.g., keyboard), audio input (e.g., microphone), video interface (e.g., camera), or other interface for receiving user inputs (e.g., a mouse or touch display).

As illustrated, the method 700 includes a number of enumerated steps, but aspects of the method 700 may include additional steps before, after, and in between the enumerated steps. In some aspects, one or more of the enumerated steps may be omitted or performed in a different order.

At step 702, the GUI agent may obtain a first dataset (e.g., 205 in FIG. 2) including multiple GUI trajectories of observations (e.g., 221 in FIG. 2) of the different computing platforms and corresponding GUI actions (e.g., 223 in FIG. 2). For example, at least one GUI trajectory of the multiple GUI trajectories includes one or more of: one or more image observations of the different computing platforms, one or more system-level instructions for the different computing platforms, and one or more atomic GUI actions. The different computing platforms comprise one or more of: a web platform, a desktop platform, an application specific platform, and a mobile platform.

At step 704, a vision-language model (e.g., 125 in FIG. 2) deployed on one or more hardware processors may be trained using the first dataset to generate one or more platform-specific GUI actions in response to a user task request relating to a specific computing platform. For example, the one or more platform-specific GUI actions are selected from an action space combining different types of actions across the different computing platforms. In response to detecting the new action from a GUI trajectory, a new action may be with an existing action in the action space. Or in response to determining that the new action does not map to any existing action in the action space, the new action may be added as associated with a natural language description compliant of an action format of the action space.

At step 706, the GUI agent may obtain a second dataset (e.g., 208 in FIG. 2) including a plurality of natural language descriptions representing reasoning (e.g., 225 in FIG. 2) for the corresponding GUI actions. For example, the second dataset including the plurality of natural language descriptions representing reasoning for the one or more platform-specific GUI actions may be generated by a multi-modal language model based on the multiple GUI trajectories in the first dataset, e.g., as shown in FIG. 3.

At step 708, the vision-language model (e.g., 125 in FIG. 2), trained after step 704, may be trained again using the second dataset to generate associated reasoning for the one or more platform-specific GUI actions.

At step 710, the GUI agent may be built on the trained vision-language model to automate a series of GUI actions (e.g., 122 in FIG. 1B) executed on the specific computing platform (e.g., 109 in FIG. 1B) based on captured visual observations (e.g., 121 in FIG. 1B) of the specific computing platform thereby causing the computing platform to evolve into a solution to the user request (e.g., 106 in FIG. 1A).

At step 712, the GUI agent may further cause a display of reasoning (e.g., 124 in FIG. 1B) associated with the series of GUI actions while the series of GUI actions is being executed on the specific computing platform.

In one embodiment, for example, the GUI may be associated with an application relating to a diagnostic request in view of a medical record in a healthcare system, a curriculum designing request in an online education system, a code generation request in a software development system, a writing and/or editing request in a content generation system, an IT diagnostic request in an IT customer service support system, a navigation request in a robotic and autonomous system, and/or the like. By performing embodiments described herein, the neural network based artificial agent may improve technology in the respective technical field in healthcare and diagnostics, education and personalized learning, software development and code assistance, content creation, autonomous system (such as autonomous driving, etc.), and/or the like.

For example, when the task query includes a query to identify an information technology (IT) anomaly relating to a usage of an IT component such as a network gateway, a router, an online printer, and/or the like, by performing method 700 at an environment of a local area network (LAN), the neural network based artificial agent may receive an observation from the environment at which the next-step action is executed, and determine that the observation representing an information technology anomaly (e.g., a router failure, an unauthorized access attempt, a domain name system anomaly, and/or the like). In some implementations, the neural network based artificial agent may cause an alert relating to the information technology anomaly to be displayed at a visualized user interface. In some implementations, the neural network based artificial agent may generate atomic actions to identify the origin of the anomaly, and therefore block traffic from the origin for a period of time. In this way, IT anomalies may be detected and alerted using the neural network based artificial agent in an efficient manner so as to improve network support technology.

### Example Data Experiments

In one embodiment, to evaluate the effectiveness of GUI agent described in FIGS. 1A-7 across different platforms, example experiments were conducted on several GUI benchmarks, including GUI Grounding Evaluation and Offline/Online GUI Agent Evaluation. The initial assessment focused on GUI grounding performance, a fundamental capability of GUI agent models. Evaluation was performed using the ScreenSpot dataset, which features a range of grounding instructions designed for mobile, desktop, and website platforms. Two evaluation settings were used: (1) Original Instructions, where models execute grounding actions directly based on the provided instructions, and (2) Self-plan, where models first generate natural language plans from the original instructions before performing grounding actions.

As shown in Table 1, GUI agent (e.g., 110, 430, referred to as “AGUIVIS”) demonstrates strong GUI grounding capabilities under both evaluation settings across multiple platforms. With the proposed grounding training, AGUVIS-G-7B significantly surpasses existing models in the Original Instructions setting, indicating robust universal GUI grounding performance. After training on high-quality planning trajectory data, AGUVIS further exhibits strong planning capabilities, outperforming prior models that depend on external closed-source large language models. Additionally, scaling up the model parameters, AGUVIS-72B achieves state-of-the-art performance, reaching an average score of 89.2.

TABLE 1
Comparison of Different Planners and Grounding Methods

| | | Mobile | | Desktop | | Web | | |
|---|---|---|---|---|---|---|---|---|
| Planner | Grounder | Text | Icon/Widget | Text | Icon/Widget | Text | Icon/Widget | Avg |
| — | GPT-4 | 22.6 | 24.5 | 20.2 | 11.8 | 9.2 | 8.8 | 16.2 |
| | GPT-4o | 20.2 | 24.9 | 21.1 | 23.6 | 12.2 | 7.8 | 18.3 |
| | CogAgent | 67.0 | 24.0 | 74.2 | 20.0 | 70.4 | 28.6 | 47.4 |
| | SeeClick | 78.0 | 52.0 | 72.2 | 30.0 | 55.7 | 32.5 | 53.4 |
| | Qwen2-VL | 75.5 | 60.7 | 76.3 | 54.3 | 35.2 | 25.7 | 55.3 |
| | UGround | 82.8 | 60.3 | 82.5 | 63.6 | 80.4 | 70.4 | 73.3 |
| | AGUVIS-G-7B | 88.3 | 78.2 | 88.1 | 70.7 | 85.7 | 74.8 | 81.8 |
| GPT-4 | SeeClick | 76.6 | 55.5 | 68.0 | 28.6 | 40.9 | 23.3 | 48.8 |
| | OmniParser | 93.9 | 57.0 | 91.3 | 63.6 | 81.3 | 51.0 | 73.0 |
| | UGround | 90.1 | 70.3 | 87.1 | 55.7 | 85.7 | 64.6 | 75.6 |
| GPT-4o | SeeClick | 81.0 | 59.8 | 69.6 | 33.6 | 43.9 | 26.2 | 52.3 |
| | UGround | 93.4 | 76.9 | 92.8 | 67.9 | 88.7 | 68.9 | 81.4 |

| | | | | | | | |
|---|---|---|---|---|---|---|---|
| AGUVIS-7B | 95.6 | 77.7 | 93.8 | 67.1 | 88.3 | 75.2 | 84.4 |
| AGUVIS-72B | 94.5 | 85.2 | 95.4 | 77.9 | 91.3 | 85.9 | 89.2 |

In one embodiment, the dataset Multimodal-Mind2Web has been used to evaluate the offline planning capabilities of GUI agents on websites, building upon the original Mind2Web framework. Comparisons have been made with prior approaches, including closed large language models using text-only inputs or state-of-mind (SOM) representations, as well as recent pure vision-based agent models. In alignment with previous methodologies, AGUVIS utilized only GUI screenshots as observations. Element accuracy (Ele.Acc), Operation F1 (Op.F1), and step success rate (Step SR) are reported. As shown in Table 2, AGUVIS consistently achieves superior performance, with a notable improvement in Step SR (+51.9% on average), indicating enhanced planning and reasoning capabilities.

TABLE 2
Performance comparison on Multimodal Mind2Web across different settings

| | | | Cross-Task | | | Cross-Website | | | Cross-Domain | | |
|---|---|---|---|---|---|---|---|---|---|---|---|
| Obs. | Planner | Grounder | Ele. Acc | Op. F1 | Step SR | Ele. Acc | Op. F1 | Step SR | Ele. Acc | Op. F1 | Step SR |
| T | GPT-3,5 | Choice | 19.4 | 59.2 | 16.8 | 14.9 | 56.5 | 14.1 | 25.2 | 57.9 | 24.1 |
| | GPT-4 | Choice | 40.8 | 63.1 | 32.3 | 30.2 | 61.0 | 27.0 | 35.4 | 61.9 | 29.7 |
| T + 1 | GPT-4 | Choice | 46.4 | 73.4 | 40.2 | 38.0 | 67.8 | 32.4 | 42.4 | 69.3 | 36.8 |
| | GPT-4 | SoM | 29.6 | — | 20.3 | 20.1 | — | 13.9 | 27.0 | — | 23.7 |
| 1 | — | SeeClick | 23.8 | — | — | 15.3 | — | — | 16.2 | — | — |
| | — | CogAgent | 54.2 | — | — | 50.0 | — | — | 54.7 | — | — |
| 1 | GPT-4o | SeeClick | 32.1 | — | — | 33.1 | — | — | 33.5 | — | — |
| | GPT-4V | OmniParser | 42.4 | 87.6 | 39.4 | 41.0 | 84.8 | 36.5 | 45.5 | 85.7 | 42.0 |
| | GPT-4o | UGround | 47.7 | — | — | 46.0 | — | — | 46.6 | — | — |

| | | | | | | | | | | |
|---|---|---|---|---|---|---|---|---|---|---|
| 1 | AGUVIS-7B | 64.2 | 89.8 | 60.4 | 60.7 | 88.1 | 54.6 | 60.4 | 89.2 | 56.6 |
| | AGUVIS-72B | 69.5 | 90.8 | 64.0 | 62.6 | 88.6 | 56.5 | 63.5 | 88.5 | 58.2 |

Additionally, the planning performance of GUI agent models on mobile devices was assessed using AndroidControl. Following the established evaluation protocol, 500 step-actions were randomly sampled to create a subset, and step accuracy was reported on out-of-domain (OOD) data across both high-level and low-level tasks. In the high-level task setting, the model is required to plan and execute actions, whereas in the low-level setting, the model must follow human-labeled instructions to perform the next action. Baseline comparisons were made with models using either textual accessibility trees or GUI images as observations. Table 3 shows that AGUVIS achieves the best performance under both evaluation settings.

TABLE 3
Step Accuracy of out-of-domain (OOD) data on AndroidControl

| | | | Step Accuracy | |
|---|---|---|---|---|
| | | | High- | Low- |
| Observation | Planner | Grounder | Level | Level |
| Acc. Tree | GPT-4-Turbo | Choice | 42.1 | 55.0 |
| | PaLM 2S (Specialized) | Choice | 58.5 | 77.5 |
| Image | GPT-4-Turbo | SeeClick | 39.4 | 47.2 |
| | GPT-4-Turbo | UGround | 46.2 | 58.0 |
| | GPT-4o | SeeClick | 41.8 | 52.8 |
| | GPT-4o | UGround | 48.4 | 62.4 |

| | | | |
|---|---|---|---|
| Image | AGUVIS-7B | 61.5 | 80.5 |
| | AGUVIS-72B | 66.4 | 84.4 |

In one embodiment, beyond offline planning, additional data experiments are carried out on real-time interaction benchmarks, including Mind2Web-Live, AndroidWorld, and MobileMiniWob:

Mind2Web-Live is a dynamic dataset operating in a real web-based environment, derived from the original Mind2Web. This benchmark measures task success by evaluating whether each required step within a task has been completed, with task success rate (Task SR) reported as the main metric.

AndroidWorld is a benchmark running in an Android virtual environment that dynamically generates unique tasks through random parameter instantiation, allowing for automatic evaluation. To assess pure vision-based agent models, a Pixel 6 phone simulator was installed on experimental systems following standard procedures. AndroidWorld includes a fully automated task-level evaluation system that verifies whether a designated task has been successfully completed.

MobileMiniWob adapts 92 tasks from MiniWob++ into the AndroidWorld environment. The same observation and action spaces from AndroidWorld are employed, and task success rate is determined using a real-time evaluation function.

Two experimental configurations are explored: in the first setup, GPT-4o serves as the planner in collaboration with AGUVIS-7B as the grounder. In the second configuration, AGUVIS-72B is used in a dual role, functioning as both planner and grounder. Performance was compared with existing state-of-the-art methods that also utilize GPT-4o models as planners. Unlike previous approaches that depend on Set-of-Mark (SOM) representations or textual HTML/AXTree information, AGUVIS relies solely on screenshots as observations and is restricted to pyautogui-based actions across all environments. The screenshot viewport is set to a resolution of 1280×720, and all actions based on HTML/AXTree selection are disabled.

As shown in Table 4 and Table 5, when GPT-4o is used as the planner, AGUVIS-7B outperforms existing methods in task success rate across multiple benchmarks. Furthermore, employing AGUVIS-72B as both planner and grounder resulted in the best performance on Mind2Web-Live and MobileMiniWob, highlighting the potential advantages of purely visual agent models for autonomous GUI interactions. In addition, AGUVIS-72B demonstrates significant efficiency advantages over both closed-source and open-source models, suggesting strong potential for applying purely visual agents in real-world online scenarios.

TABLE 4
Task Success Rate (SR) and efficiency costs on Mind2WebLive

| Inputs | Planner | Grounder | Task SR | USD Efficiency |
|---|---|---|---|---|
| HTML | GPT-4-Turbo | Choice | 21.1 | — |
| | GPT-4o | Choice | 22.1 | 0.142 |
| | Llama-3.1-405B | Choice | 24.0 | 0.174 |
| | Llama-3.1-70B | Choice | 20.2 | 0.031 |
| | GPT-3.5-turbo | Choice | 17.3 | 0.092 |
| Image | GPT-4-Turbo | UGround | 23.1 | — |
| | GPT-4o | UGround | 19.2 | — |
| | GPT-4o | AGUVIS-7B | 24.0 | 0.106 |

| | | | |
|---|---|---|---|
| Image | AGUVIS-72B | 27.1 | 0.012 |

TABLE 5
Task Success Rates (SR) on AndroidWorld and MobileMiniWob

| Input | Planner | Grounding | AndroidWorld_{SR} | MobileMiniWob_{SR} |
|---|---|---|---|---|
| AXTree | GPT-4- | Choice | 30.6 | 59.7 |
| | Turbo | | | |
| | Gemini | Choice | 19.4 | 57.4 |
| | 1.5 Pro | | | |
| Image + | GPT-4- | SoM | 25.4 | 67.7 |
| AXTree | Turbo | | | |
| | Gemini | SoM | 22.8 | 40.3 |
| | 1.5 Pro | | | |
| Image | GPT-4- | UGround | 31.0 | — |
| | Turbo | | | |
| | GPT-4o | UGround | 32.8 | — |
| | GPT-4o | AGUVIS- | 37.1 | 55.0 |
| | | 7B | | |

| | | | |
|---|---|---|---|
| Image | AGUVIS-72B | 26.1 | 66.0 |

This description and the accompanying drawings that illustrate inventive aspects, embodiments, implementations, or applications should not be taken as limiting. Various mechanical, compositional, structural, electrical, and operational changes may be made without departing from the spirit and scope of this description and the claims. In some instances, well-known circuits, structures, or techniques have not been shown or described in detail in order not to obscure the embodiments of this disclosure. Like numbers in two or more figures represent the same or similar elements.

In this description, specific details are set forth describing some embodiments consistent with the present disclosure. Numerous specific details are set forth in order to provide a thorough understanding of the embodiments. It will be apparent, however, to one skilled in the art that some embodiments may be practiced without some or all of these specific details. The specific embodiments disclosed herein are meant to be illustrative but not limiting. One skilled in the art may realize other elements that, although not specifically described here, are within the scope and the spirit of this disclosure. In addition, to avoid unnecessary repetition, one or more features shown and described in association with one embodiment may be incorporated into other embodiments unless specifically described otherwise or if the one or more features would make an embodiment non-functional.

Although illustrative embodiments have been shown and described, a wide range of modification, change and substitution is contemplated in the foregoing disclosure and in some instances, some features of the embodiments may be employed without a corresponding use of other features. One of ordinary skill in the art would recognize many variations, alternatives, and modifications. Thus, the scope of the invention should be limited only by the following claims, and it is appropriate that the claims be construed broadly and, in a manner, consistent with the scope of the embodiments disclosed herein.

What is claimed is:

1. A computer-implemented method for building a graphical user interface (GUI) agent to automate tasks across different computing platforms, the method comprising:
obtaining a first dataset including multiple GUI trajectories of observations of the different computing platforms and corresponding GUI actions;
training a vision-language model deployed on one or more hardware processors using the first dataset to generate one or more platform-specific GUI actions in response to a user task request relating to a specific computing platform;
obtaining a second dataset including a plurality of natural language descriptions representing reasoning for the corresponding GUI actions;
training the vision-language model using the second dataset to generate associated reasoning for the one or more platform-specific GUI actions;
automating, by the GUI agent built on the trained vision-language model, a series of GUI actions executed on the specific computing platform based on captured visual observations of the specific computing platform thereby causing the computing platform to evolve into a solution to the user request; and
causing a display of reasoning associated with the series of GUI actions while the series of GUI actions is being executed on the specific computing platform.

2. The computer-implemented method of claim 1, wherein at least one GUI trajectory of the multiple GUI trajectories includes one or more of:
one or more image observations of the different computing platforms;
one or more system-level instructions for the different computing platforms; and
one or more atomic GUI actions.

3. The computer-implemented method of claim 1, wherein the different computing platforms comprise one or more of:
a web platform;
a desktop platform;
an application specific platform; and
a mobile platform.

4. The computer-implemented method of claim 1, wherein the one or more platform-specific GUI actions are selected from an action space combining different types of actions across the different computing platforms.

5. The computer-implemented method of claim 4, further comprising:
in response to detecting the new action from a GUI trajectory:
aligning a new action with an existing action in the action space.

6. The computer-implemented method of claim 5, further comprising:
in response to determining that the new action does not map to any existing action in the action space, adding the new action associated with a natural language description compliant of an action format of the action space.

7. The computer-implemented method of claim 1, wherein the plurality of natural language descriptions representing reasoning for the one or more platform-specific GUI actions are generated by a multi-modal language model based on the multiple GUI trajectories in the first dataset.

8. A system for building a graphical user interface (GUI) agent to automate tasks across different computing platforms, the system comprising:
a memory that stores a vision-language model and a plurality of processor executable instructions;
a communication interface that receives a first dataset including multiple GUI trajectories of observations of the different computing platforms and corresponding GUI actions; and
one or more hardware processors that read and execute the plurality of processor-executable instructions from the memory, wherein the plurality of processor-executable instructions are configurable to cause the system to perform operations comprising:
training a vision-language model deployed on one or more hardware processors using the first dataset to generate one or more platform-specific GUI actions in response to a user task request relating to a specific computing platform;
obtaining a second dataset including a plurality of natural language descriptions representing reasoning for the corresponding GUI actions;
training the vision-language model using the second dataset to generate associated reasoning for the one or more platform-specific GUI actions;
automating, by the GUI agent built on the trained vision-language model, a series of GUI actions executed on the specific computing platform based on captured visual observations of the specific computing platform thereby causing the computing platform to evolve into a solution to the user request; and
causing a display of reasoning associated with the series of GUI actions while the series of GUI actions is being executed on the specific computing platform.

9. The system of claim 8, wherein at least one GUI trajectory of the multiple GUI trajectories includes one or more of:
one or more image observations of the different computing platforms;
one or more system-level instructions for the different computing platforms; and
one or more atomic GUI actions.

10. The system of claim 8, wherein the different computing platforms comprise one or more of:
a web platform;
a desktop platform;
an application specific platform; and
a mobile platform.

11. The system of claim 8, wherein the one or more platform-specific GUI actions are selected from an action space combining different types of actions across the different computing platforms.

12. The system of claim 11, wherein the operations further comprise:
in response to detecting the new action from a GUI trajectory:
aligning a new action with an existing action in the action space.

13. The system of claim 12, wherein the operations further comprise:
in response to determining that the new action does not map to any existing action in the action space, adding the new action associated with a natural language description compliant of an action format of the action space.

14. The system of claim 8, wherein the plurality of natural language descriptions representing reasoning for the one or more platform-specific GUI actions are generated by a multi-modal language model based on the multiple GUI trajectories in the first dataset.

15. A non-transitory machine-readable medium comprising a plurality of instructions for building a graphical user interface (GUI) agent to automate tasks across different computing platforms, executable by one or more processors, wherein the plurality of instructions are configurable to cause the one or more processors to perform operations comprising:
obtaining a first dataset including multiple GUI trajectories of observations of the different computing platforms and corresponding GUI actions;
training a vision-language model deployed on one or more hardware processors using the first dataset to generate one or more platform-specific GUI actions in response to a user task request relating to a specific computing platform;
obtaining a second dataset including a plurality of natural language descriptions representing reasoning for the corresponding GUI actions;
training the vision-language model using the second dataset to generate associated reasoning for the one or more platform-specific GUI actions;
automating, by the GUI agent built on the trained vision-language model, a series of GUI actions executed on the specific computing platform based on captured visual observations of the specific computing platform thereby causing the computing platform to evolve into a solution to the user request; and
causing a display of reasoning associated with the series of GUI actions while the series of GUI actions is being executed on the specific computing platform.

16. The non-transitory machine-readable medium of claim 15, wherein at least one GUI trajectory of the multiple GUI trajectories includes one or more of:
one or more image observations of the different computing platforms;
one or more system-level instructions for the different computing platforms; and
one or more atomic GUI actions.

17. The non-transitory machine-readable medium of claim 15, wherein the different computing platforms comprise one or more of:
a web platform;
a desktop platform;
an application specific platform; and
a mobile platform.

18. The non-transitory machine-readable medium of claim 15, wherein the one or more platform-specific GUI actions are selected from an action space combining different types of actions across the different computing platforms.

19. The non-transitory machine-readable medium of claim 18, further comprising:
in response to detecting the new action from a GUI trajectory, aligning a new action with an existing action in the action space; or
in response to determining that the new action does not map to any existing action in the action space, adding the new action associated with a natural language description compliant of an action format of the action space.

20. The non-transitory machine-readable medium of claim 15, wherein the plurality of natural language descriptions representing reasoning for the one or more platform-specific GUI actions are generated by a multi-modal language model based on the multiple GUI trajectories in the first dataset.
